(19) United States
(12) Patent Application Publication
(10) Pub. No.: US 2024/0227014 A1
(43) Pub. Date: Jul. 11, 2024

(54) LASER OPERATING MACHINE FOR LASER SINTERING

(71) Applicant: MORPHICA S.R.L., MONOPOLI (IT)

(72) Inventors: Sante Calefati, Monopoli (IT); Nicolai Valenti, Monopoli (IT)

(21) Appl. No.: 18/560,295

(22) PCT Filed: Apr. 6, 2022
(86) PCT No.: PCT/IT2022/050085

§ 371 Date: Nov. 10, 2023

(30) Foreign Application Priority Data
May 13, 2021 (IT) 102021000012392

(51) Int. Cl. B22F 10/28; B22F 10/32; B22F 10/77; B22F 12/13; B22F 12/47; B22F 12/48; B22F 12/67; B22F 12/70; B22F 12/90; B33Y 10/00; B33Y 30/00; B33Y 50/02

(52) U.S. Cl. CPC B22F 10/28; B22F 10/32; B22F 10/77; B22F 12/13; B22F 12/47; B22F 12/48; B22F 12/67; B22F 12/70; B22F 12/90; B33Y 10/00; B33Y 30/00; B33Y 50/02

(57) ABSTRACT

A laser operating machine for laser sintering (100) is described for making three-dimensional objects starting from a digital 3D model by sintering the layers with the use of a laser source and an optical system, mechanical means for depositing a powder bed on a work surface, and a mechanical system to remove the fumes and/or pollutants deriving from the selective powder melting process as close as possible to the melted layer or layer, before they are dispersed inside the work chamber, and to introduce in the same chamber the process gases necessary for the processing of powder bed fusion in a localized manner, close to the layers or layers subject to the selective melting process.

The present invention refers to a laser operating machine for in laser sintering, accordance with the preamble of claim 1. In particular, an innovative sintering system is described, for additive manufacturing with powder bed fusion technology or with a bed of metal powder and/or resin and/or polymeric material.

Additive Manufacturing (AM) is a set of additive manufacturing inpowderrial processes to manufacture objects starting from digital models, as opposed to traditional subtractive techniques, such as for example machining by chip removal, cutting and drilling, which start from a block of material from which the shavings are mechanically removed; starting from computerized 3D models of a specific object, it is possible to carry out a subdivision into layers or layers with the aid of a software integrated in the control system of the machine, or from online services, in order to obtain a scheme of resulting layers that will be processed by a machine tool for the sintering, or deposition, process of different types of materials, such as metals, plastics, resins, polymers and composite components.

The main feature of this technology is that it is a production process that allows the creation of components with a geometry very close to that of the final component, as required by the project drawing. In the AM family, some technologies with different characteristics can be identified, such as the selective melting/sintering of a powder bed of materials such as metals, plastics, resins, polymers and composite components, using a laser beam (Selective Laser Beam Melting—SLBM or Selective Laser Beam Sintering—SLBS), or also known as Powder Bed Fusion or PBF, binder jet casting, fused filament fabrication, stereolithography (SLA), in which powder from materials such as metals, plastic resins, polymers and composite components is deposited on a construction support before the interaction with the energy source, and the deposition of metal by laser beam (Laser Beam Metal Deposition—LBMD), in which the powder is sprayed on the support with the aid of one or more nozzles and at the same time is hit by the energy beam, and selective electron beam melting (SEB M).

In the powder bed technology of materials such as metals, plastics, resins, polymers and composite components or PBFs, a laser beam, by means of a lens system and a scanner, is used as a source of high power density heat, necessary to lead to melt the powders of materials such as metals, plastics, resins, polymers and composite components only in certain predetermined areas, in which compact material must be obtained for the construction of the three-dimensional component. In particular, the powder contained in special hoppers is sent with a feeding system on the construction surface and is distributed through a doctor blade in a layer generally of 20-60 μm, which will then be selectively hit by the laser beam according to the desired geometry. The advantage linked to the use of a laser beam is that it can be focused on small dimensions, typically in the range between 30 μm and 180 μm in diameter, and therefore guarantees high power densities which lead to a rapid melting of the powder and to a good level of precision, in terms of surface finish, of the part to be made. The substrate together with the powder bed that is not hit by the laser beam provides mechanical support for the piece under construction: in fact, after the first layer has been completed, the platform is lowered, new powder is distributed and the layers that are already deposited must not move. The building plate also has the important task of dissipating heat that is created during the process, and in some cases it can also be heated, in order to lower the thermal gradient with the piece under construction, which could lead to the formation of high voltages, residuals and consequent deformation of the component. In order to make the most of the work area, it is also possible to build multiple pieces within the same powder bed. Usually, the powder bed process is carried out in a chamber into which inert gas is blown in order to prevent oxidation of the material. These characteristics have allowed access to the inpowderrial market of powder bed technology, for the production of components in different sectors, from aerospace to medical, from automotive to jewelry. In particular, compared to traditional production technologies, it is possible to achieve very high levels of component customization, given the great flexibility of the powder bed technology.

The powder bed or PBF process is characterized by various factors that determine the final properties of the components produced, in terms of density, microstructure and mechanical properties; in particular, it depends on the radiation-matter interaction or on the absorption properties of the materials of the energy of electromagnetic radiation and on the temperature of the powder bed. The absorption properties of a material include parameters such as density, thermal conductivity, specific heat and emissivity, and vary with the temperature of the material itself, which, in the additive manufacturing technology in powder bed or powder bed fusion, determines the material processing process.

The choice of process parameters such as laser power, laser scanning speed on the powder bed, shape of the laser beam and material used affect the structural and surface quality of the components produced and the productivity of the system, which becomes decisive for the use of this type of machinery in the inpowderrial field, especially in sectors today covered by foundry and/or hot molding and/or die casting, due also to their advantages such as high spatial resolution, capillary process control and the ability to carry out a pre-processing of the powder bed and post-processing of the freshly melted material.

The fusion process by means of the laser source takes place inside a working chamber under an atmosphere of an inert gas (for example nitrogen, argon, etc.), inside which there are some handling devices that allow controlling the adduction of the powder, and therefore guaranteeing the realization of the component, the aspiration of fumes deriving from the selective melting process and the introduction of gas support to the production process.

Many systems for sintering metal powders with additive manufacturing technology are known in the art, such as for example document WO2018/151911 concerning an additive manufacturing system with a laser matrix, each of which generates an energy beam to form a bath of powder bed fusion, or document WO2018/156254, which describes an additive manufacturing system comprising a device with a powder bed and a series of laser emitters, configured to melt at least a portion of the powder bed as it moves relative to the powder bed and which includes a manifold configured to aspirate the fumes, and also document EP3050648 related to a system of inlet and aspiration of gas from the work area, with the inflow nozzle and the outlet nozzle arranged in such a way as to create a flow of gas which passes at least partially above the work and junction area.

The main prior art disadvantage concerns sintering systems in which the optical systems necessary for the transport of the electromagnetic radiation are fixed and multiple above the work surface, and not mobile along the powder bed, as well as the extraction of the process fumes, and the input of the support gases is not localized, but limited to the boundary walls of the work chamber, which are also not localized near the processes carried out in the layer or layers of powder by the laser used, limits that introduce a complex process of alignment of the optical the components on the work surface, as well as t formation of defects and/or inclusions within the molten material and therefore in the final components with small and/or large dimensions. Furthermore, these are devices without a fireproof system for containing the gases necessary for the sintering process using additive manufacturing technology.

Object of the present invention is solving the aforementioned prior art problems by means of a laser operating machine (100) for laser sintering, through a mechanical and technological solution with a simple optical system free from complex alignment procedures, designed to convey and focus the beam of electromagnetic radiation emitted by the laser in a predetermined area of a work surface; another purpose is providing a mechanical solution capable of locally removing the process fumes from the worktop and introducing the process assistance gases into the powder bed with the aid of a system integral with the optical system. Another object is the use of a fireproof system to contain the gases necessary for the sintering process using additive manufacturing technology.

The aforesaid and other objects and advantages of the invention, as will emerge from the following description, are achieved with a laser operating machine for laser sintering such as that described in claim 1. Preferred embodiments and non-trivial variants of the present invention form the subject matter of dependent claims.

It is understood that all attached claims form an integral part of the present description.

It will be immediately obvious that innumerable variations and modifications (for example relating to shape, dimensions, arrangements and parts with equivalent functionality) can be made to what is described, without departing from the scope of the invention as appears from the attached claims.

The present invention will be better described by some preferred embodiments, provided by way of a non-limiting example, with reference to the attached drawings, in which:

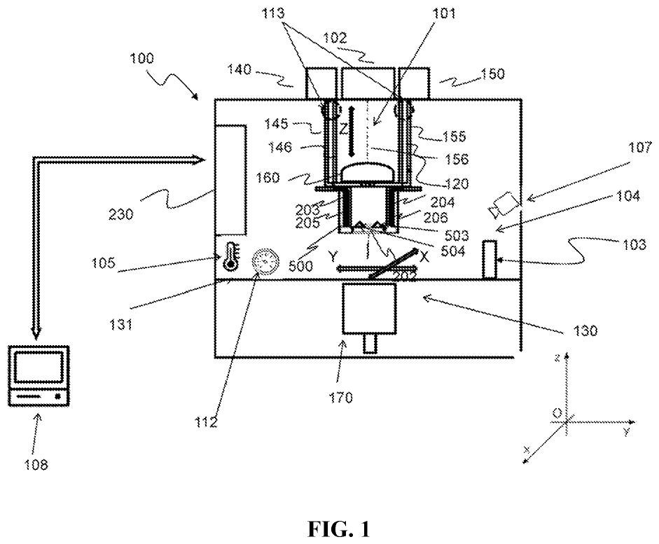

FIG. 1 shows the laser operating machine (100) for laser sintering according to the present invention;

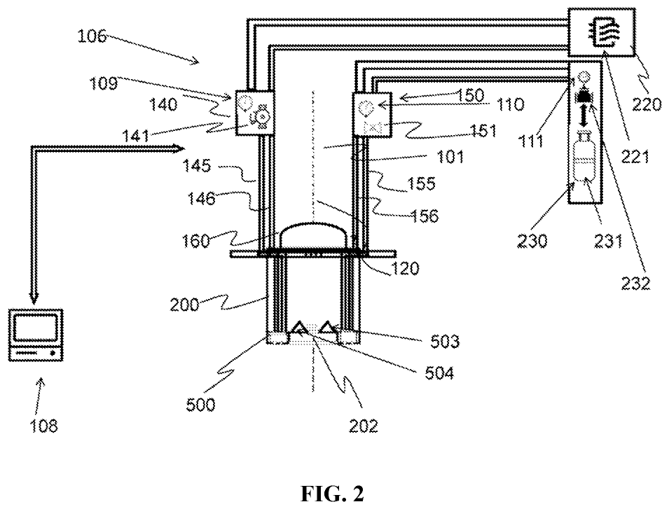

FIG. 2 shows the optical system (101) and the gas suction and injection system (106) according to the present invention;

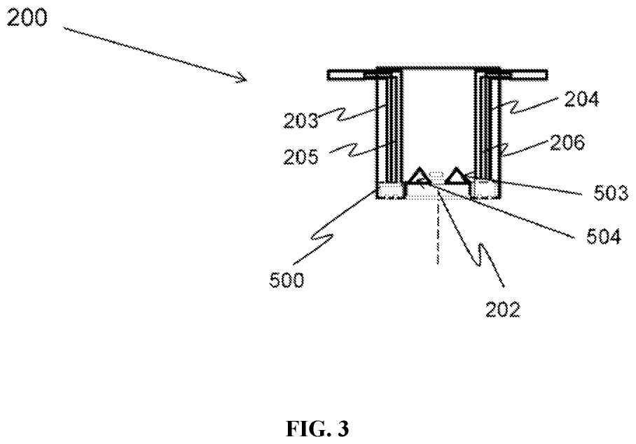

FIG. 3 shows the terminal part of the optical system (101) and the gas intake and intake system (106) according to the present invention;

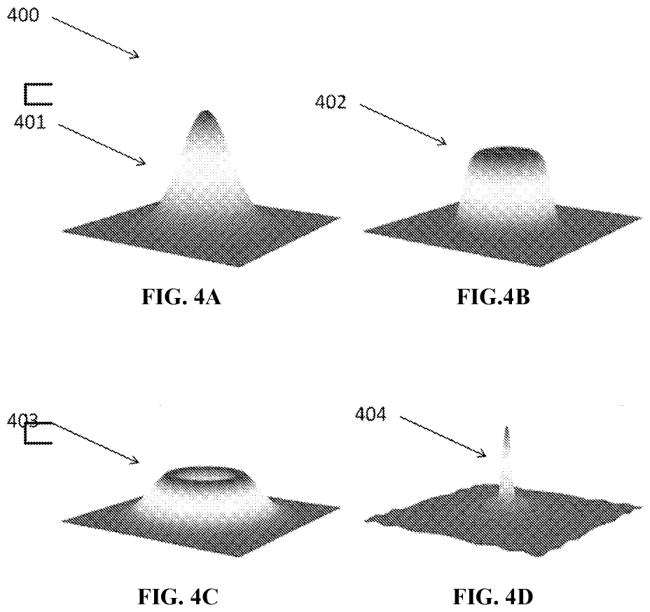

FIG. 4 shows the modes of the electromagnetic radiation beam (120) according to the present invention;

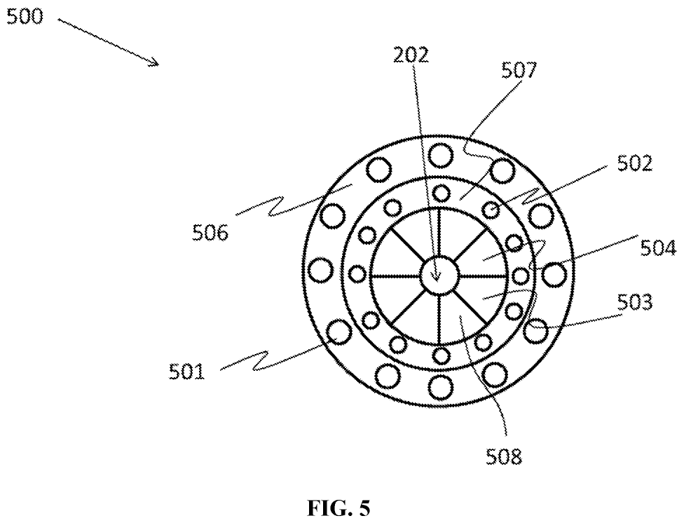

FIG. 5 shows a front view of the ring nut (500) of the optical system (101) and the gas intake and inlet (106) according to the present invention.

The laser machine (100) for laser sintering for additive manufacturing is designed to create three-dimensional objects starting from a digital 3D model by sintering the layers with the use of a laser source and an optical system, mechanical means suitable for deposit a powder bed of materials such as metals, plastics, resins, polymers and composite components on a work surface with the aid of multiple sensors necessary for process control, and a mechanical system to remove fumes and/or pollutants deriving from the selective melting process of the powder as close as possible to the melted layer or layers, before they disperse inside the working chamber, and to introduce in the same chamber the process gases necessary for the processing of powder bed fusion or powder bed in a localized way, close to the layers or layers subject to the selective fusion process; it consists of an optical system (101) designed to convey and focus the beam of electromagnetic radiation (120) emitted by the laser (102) in a predetermined area of a work surface (130), the optical system being connected to the upper surface part of a laser operating machine (100), a work surface (130), designed to house a powder bed of materials such as metals, plastics, resins, polymers and composite components (131), operatively connected to a piston (170), a system (106) for the extraction of fumes and the introduction of support gases, designed to locally remove the process fumes from the work surface (130) and to introduce the process assistance gases into the powder bed of materials such as metals, plastic resins, polymers and composite components (131), the system (106) operatively connected to the optical system (101), and a gas container unit (230), designed to contain the process gas cylinders, which is fire-proof, operatively connected to the laser operating machine (100), as can be seen from FIG. 1.

The laser operating machine (100) for laser sintering is equipped with an optical system (101) capable of moving along the X, Y and Z axes within the perimeter of the work surface (130) by means of mechanical and/or magnetic drives (113), the optical system (101) being free from complex alignment procedures which, in one or more embodiments, can consist of at least one optic able to collimate the beam of electromagnetic radiation (120) by means of reflection and/or refraction of the beam of electromagnetic radiation (120) and by at least one optic able to focus the beam of electromagnetic radiation (120) in the work surface (130) in which a plate, necessary to dissipate the heat that is generated, is housed during the casting process, and which can be heated in order to lower the thermal gradient with the piece under construction which could lead to the formation of high residual stresses and consequent deformation of component, and the optics being also reflected and/or transmissive, for additive manufacturing processes and applications.

Advantageously, as can be seen from FIG. 1, the optical system (101) consists of one or more reflective and/or transmissive, fixed and/or mobile optical elements (160), necessary to modify the diameter and shape of the laser beam, be it Gaussian (401), top-hat (402), donut (403) or Bessel (404), and the position along the Z axis of the spot of the beam of electromagnetic radiation (120) emitted by the laser (102) and to focus the beam of electromagnetic radiation (120) emitted by the laser (102) with a wavelength in the 180 nm-11000 nm range in output from a central area (202) of a cylindrical and/or conical nozzle (200), connected to a ring nut (500), in the predetermined area of a work surface (130), to carry out additive manufacturing processes. The focal spot of a laser beam means its smallest diameter on the focal plane when it is focused by a reflective and/or transmissive optic, in the space of the caustic which represents the set of curves that model the propagation of light rays emitted by a collimated laser source, this diameter or spot being the area around the propagation axis of the laser beam in which most of the laser source power is concentrated. A laser beam can be of the Gaussian type (401) when its intensity profile, on a plane perpendicular to the direction of propagation, follows a Gaussian distribution and the energy distribution is more concentrated in the central part and decreases in the direction of the tails, of the top type hat (402) when its intensity profile is mostly flat, and the energy distribution is more concentrated in the central part and tends to zero along the edges, of the donut (403) or donut type due to its characteristic shape, in which the energy distribution is more concentrated in a ring that surrounds its shape and has a minimum point in the central part and tends to decrease in the direction of the tails, and of Bessel (404) whose amplitude is described by a function of Bessel of the first type, and while it propagates it does not diffract and does not spread, as can be seen from FIGS. 4a, 4b, 4c and 4d.

The laser operating machine (100) for laser sintering can be equipped with a laser source (102) integral with and connected to the upper part of the optical system (101) as shown in FIG. 1, or the laser source (102) can be located not necessarily above the optical system (101); furthermore, the laser operating machine for laser sintering (100) is provided with a doctor blade or recoater (103) operatively connected to the work surface (130) by means of movement means, such as for example actuators and/or sliding tracks, the doctor blade or recoater (103) being designed for spreading the bed of metal powder and/or resin and/or polymeric material (131) in the work surface (130) for additive manufacturing applications.

Advantageously, the system (106) for the aspiration of fumes and the introduction of support gases is operatively connected to the optical system (101), and is designed to translate in the X, Y and Z direction of the work surface (130), as can be seen from FIGS. 1 and 2 and the system (106) for the aspiration of fumes and for the introduction of support gases is able to locally introduce the gases necessary for the process into the bed of metal powder and/or resin and/or polymeric material (131) in the work surface (130), and to locally aspirate the process fumes from the bed of metal powder and/or resin and/or polymeric material (131) in the work surface (130) in the machine tool (100).

The system (106) for the suction of the fumes and for the inlet of the support gases is designed to convey the suction of the process fumes through at least two channels (203) and (204) connected to the nozzle (200), and preferably concentric to the nozzle (200) in the ring nut (500) and to a suction unit (140) by means of at least one duct (145) and a duct (146) and the system (106) for suctioning the fumes and introducing gases support is provided with a pump (141) necessary for the local suction of the fumes deriving from the process in the work surface (130), the pump (141) connected to the suction unit (140) by means of the ducts (145) and (146) and to a filtration unit (220), as can be seen from FIGS. 2 and 3. In addition, the ring nut (500) of circular or for example square and/or conical shape, connected to the terminal part of the nozzle (200) of the system (106) for the aspiration of the fumes and the introduction of the support gases, is constituted by an external ring (506) provided with a set of outlets (501), of circular and/or square and/or rectangular shape, suitable for sucking the process fumes from the work area (130).

Furthermore, the system (106) for the aspiration of fumes and the inlet of support gases is designed to convey the inlet of the gases through at least two channels (205) and (206) connected to the nozzle (200), and preferably concentric to the nozzle (200) in the ring nut (500) and to a delivery unit (150) by means of at least one duct (155) and a duct (156) and the system (106) for the aspiration of fumes and the inlet of gases support is provided with a solenoid valve (151) necessary for the local delivery of the support gases to the process in the work surface (130), the solenoid valve (151) connected to a delivery unit (150) by means of the ducts (155) and (156) and a container gas unit (230). In addition, the ring nut (500) of an approximately circular shape, connected to the terminal part of the nozzle (200) of the system (106) for aspirating the fumes and for introducing the support gases, is constituted by an intermediate ring (507) provided with a set of circular and/or square and/or rectangular nozzles (502), suitable for extracting the process fumes from the work area (130).

The flue gas extraction and support gas intake system (106) is equipped with an air treatment unit (221), i.e. an equipment for the treatment of air in closed environments, necessary for purification and filtering of fumes deriving from the additive manufacturing process and for air recirculation, the air treatment unit (221) connected to the filtration unit (220); furthermore, the system (106) for the aspiration of fumes and for the inlet of support gases is provided with a sensor (109) for controlling the flow of aspirated particles and a sensor (110) for controlling the flow of dispensed particles, the sensors (109) and (110) operatively connected to the pump (141) and to the solenoid valve (151) and to a control unit (108) in the machine tool (100).

Advantageously, the ring nut (500) connected to the terminal part of the nozzle (200) is designed with an inner ring (508) in which a set of fixed and/or removable energy sources (503) are located, necessary for heating operations before the start of the melting process and/or after the melting process of the metal powders in the work area (130) and, in the case of polymeric, plastic and/or resin-based materials, also of the fixed and/or removable energy sources (504), necessary for photo-polymerization operations of resinous and/or polymeric materials in the work area (130), as shown in FIG. 5.

The laser operating machine (100) for laser sintering is provided with a gas container unit (230) designed to allow the connection and removal of a container (231) of a process gas, the container (231) being connected to a valve (232) with manual fixing or with quick coupling, the gas container unit (230) being fireproof, i.e. non-flammable; moreover, the container gas unit (230) is provided with a sensor (111) for controlling the pressure of the container (231) of a process gas, necessary for the operations of insertion and removal of the container (231) of a process gas, the sensor (111) operatively connected to the valve (232) and to the control unit (108).

Advantageously, the laser operating machine (100) for laser sintering is provided with a temperature sensor (105) inside the working volume (104), this temperature sensor (105) necessary for controlling the degree of heat in the working volume (104), and with at least one optical sensor (107) necessary for checking the correct spreading of the bed of metal powder and/or resin and/or polymeric material (131), the temperature sensor (105) and the optical sensor (107) operatively connected to the walls of the machine tool (100) and to the control unit (108); moreover, inside the working volume (104), there is also a sensor (112) necessary for controlling the pressure of the working volume (104), the sensor (104) operatively connected to the walls of the machine tool (100) and to the control unit (108).

The laser operating machine (100) for laser sintering is designed to make three-dimensional objects using a powder bed fusion or a powder bed fusion technology and includes the following steps:
a powder spreading step, wherein a doctor blade or recoater (103) spreads a bed of metal powder and/or resin and/or polymeric material (131) on a work surface (130);
a laser sintering step, wherein a laser (102) emits a beam of electromagnetic radiation (120) in the bed of metal powder and/or resin and/or polymeric material (131) in a work surface (130) by means of the aid of a set of optical elements (160);
a step of aspiration and gas injection, wherein a system (106) for the aspiration of fumes and for the introduction of support gases integral with the optical system (101) which sucks the fumes deriving from the laser sintering process from the bed of metal powder and/or resin and/or polymeric material (131) in a work surface (130) and introduces the gases necessary for the laser sintering process into the powder bed (131) in a work surface (130).

Furthermore, the optical system (101) is able to move along the X, Y and Z axes within the perimeter of the work plane (130) for additive manufacturing applications, in particular the optical system (101) is able to perform machining in the positions:
above the focal point of the optical elements (160) for mechanical support applications, by mechanical or optical movement along the Z axis;
in the focal point of the optical elements (160) for processing along the contour of the layer or layers to be created, by mechanical or optical movement along the Z axis;
under the focal point of the optical elements (160) for processing within the layer or layer to be created, by mechanical or optical movement along the Z axis.

In addition, the steps of drafting the powders, laser sintering and gas suction and injection are carried out within a working volume (104) with an inert or vacuum atmosphere.

1. A laser operating machine for laser sintering comprising:
an optical system designed to convey and focus the beam of electromagnetic radiation emitted by the laser source in a predetermined area of a work surface, the optical system being connected to the upper surface of a laser operating machine;
a work surface, designed to house a bed of metal powder and/or resin and/or polymeric material, operatively connected to a piston;
a gas container unit, which is designed to contain the process gas cylinders and is fireproof, operatively connected to the laser operating machine, and
a system for the extraction of fumes and the introduction of support gases, designed to locally remove the process fumes from the work surface and to introduce the process assistance gases into the bed of metal powder and/or resin and/or polymeric material, the system operatively connected to the optical system, wherein the system for the aspiration of fumes and the introduction of support gases is designed to locally introduce the gases necessary for the process in the bed of metal powder and/or resin and/or polymeric material in the work surface, and to locally aspirate the process fumes from the bed of metal powder and/or resin material and/or polymeric in the work surface in the machine tool, the system for suction of fumes and introduction of support gases conveying the suction of process fumes by means of at least two channels and concentric and connected to a nozzle, said nozzle connected to a ring nut with an inner ring in which a set of fixed and/or removable energy sources are located, necessary for operations for heating the metal powders and/or for photo-polymerization operations of resinous and/or polymeric materials in the work area, the system for the extraction of fumes and for the introduction of supporting gases connected and to a suction unit by means of at least one duct and one duct.

2. The laser operating machine for laser sintering of claim 1, wherein the optical system is designed to move along the X, Y and Z axes within the perimeter of the work plane for additive manufacturing applications in the laser operating machine, the optical system being made up of one or more reflective and/or transmissive optical elements, fixed and/or mobile, necessary to modify the diameter and the position along the Z axis of the spot of the beam of electromagnetic radiation emitted by the laser source and to focus the beam of electromagnetic radiation emitted by the laser source exiting a central area of a nozzle of cylindrical and/or conical shape, connected to a ring nut, in the predetermined area of a work surface, to carry out additive manufacturing processes.

3. The laser operating machine for laser sintering of claim 1, wherein the optical system is provided with at least one laser source, integral or non-integral, and connected to the optical system.

4. The laser operating machine for laser sintering of claim 1, wherein a doctor blade or recoater is designed for spreading the bed of metal powder and/or resin and/or polymeric material in the work surface for additive manufacturing applications, the doctor blade or recoater operatively connected to the work surface in the machine tool.

5. The laser operating machine for laser sintering of claim 1, wherein the system for the aspiration of fumes and the introduction of support gases is designed to translate in the X, Y and Z direction of the plane working system, the system for aspirating fumes and introducing support gases operatively connected to the optical system.

6. The laser operating machine for laser sintering of claim 1, wherein the system for aspirating fumes and introducing support gases is connected to a ring nut of circular shape in the terminal part of the nozzle, the ring nut constituted by an outer ring provided with a set of outlets suitable for sucking the process fumes from the work area.

7. The laser operating machine for laser sintering of claim 1, wherein the system for aspirating fumes and introducing support gases is provided with a pump necessary for local aspiration of the fumes deriving from the process in the work surface, the pump connected to the suction unit by means of the ducts and, and to a filtration unit.

8. The laser operating machine for laser sintering of claim 1, wherein the system for aspirating fumes and for introducing support gases conveys the introduction of gases through at least two channels and connected to the nozzle, and concentric to the nozzle in the ring nut and to a delivery unit by means of at least one duct and one duct.

9. The laser operating machine for laser sintering of claim 1, wherein the system for the aspiration of fumes and the introduction of support gases is connected to a ring nut of an indicatively circular shape in the terminal part of the nozzle, the ring nut constituted by an intermediate ring provided with a set of outlets suitable for introducing the process gases into the working area.

10. The laser operating machine for laser of claim 1, wherein the system for aspirating fumes and for introducing support gases is provided with a solenoid valve necessary for locally delivering process support gases in the work surface, the solenoid valve connected to a dispensing unit by means of the ducts and, and to a gas container unit.

11. The laser operating machine for laser sintering of claim 1, wherein the system for aspirating fumes and introducing support gases is provided with an air treatment unit required for the purification and filtering of the fumes deriving from the additive manufacturing process and for the recirculation of the air, the air treatment unit connected to the filtration unit.

12. The laser operating machine for laser sintering of claim 1, wherein the system for aspirating fumes and introducing support gases is provided with a sensor by means of which it is possible to measure the content of the flow of aspirated particles and a sensor by means of which it is possible to measure the content of the flow of particles delivered, the sensors and operatively connected to the pump and to the solenoid valve and to a control unit in the machine tool.

13. The laser operating machine for laser sintering of claim 1, wherein a gas container unit is designed to allow the connection and removal of a container of a process gas, the container being connected to a quick coupling valve, the gas container unit being fireproof.

14. The laser operating machine for laser sintering of claim 1, wherein the container gas unit is provided with a sensor for controlling the pressure of the container of a gas process, necessary for the operations of insertion and removal of the container of a process gas, the sensor operatively connected to the valve and to the control unit.

15. The laser operating machine for laser sintering of claim 1, wherein inside the working volume there is a temperature sensor necessary for controlling the degree of heat in the volume and at least one optical sensor necessary for checking the correct spreading of the bed of metal powder and/or resin and/or polymeric material, the temperature sensor and the optical sensor operatively connected to the walls of the machine tool and to the control unit.

16. The laser operating machine for laser sintering of claim 1, wherein within the working volume there is a sensor necessary for controlling the pressure of the working volume, the sensor operatively connected to the walls of the machine tool and to the control unit.

17. A method for laser sintering through an additive manufacturing process, the method comprising:
a powder spreading step in which a doctor blade or recoater spreads a bed of metal powder and/or resin and/or polymeric material on a work surface;
a step of heating the metal powders and/or photopolymerization of resinous and/or polymeric materials in a work area by means of a set of fixed and/or removable energy sources located in an inner ring of a ring nut;
a laser sintering step in which a laser source emits a beam of electromagnetic radiation in the bed of metal powder and/or resin and/or polymeric material in a work surface by means of the aid of a set of optical elements;
a step of aspiration and gas injection in which a system for the aspiration of the fumes and for the introduction of the support gases integral with the optical system which sucks the fumes deriving from the laser sintering process from the bed of metal powder and/o resin and/or polymeric material in a work surface and introduces the gases necessary for the laser sintering process into the bed of metal powder and/or resin and/or polymeric material in a work surface.

18. The method of claim 17, wherein an optical system is able to move along the X, Y and Z axes within the perimeter of the work plane for additive manufacturing applications, in particular the optical system is able to perform machining in the positions:
above the focal point of the optical elements for mechanical support applications, by mechanical or optical movement along the Z axis;
in the focal point of the optical elements for processing along the contour of the layer or layer to be created, by mechanical or optical movement along the Z axis;
under the focal point of the optical elements for processing within the layer or layers to be created, by mechanical or optical movement along the Z axis.

19. The method of claim 17, wherein the steps of powder spreading, laser sintering and gas suction and injection are carried out within a working volume with an inert or vacuum atmosphere.
